(19) United States
(12) Patent Application Publication
(10) Pub. No.: US 2014/0376337 A1
(43) Pub. Date: Dec. 25, 2014

(54) TIMEPIECE ASSEMBLY WITH OVERMOULDED WHEEL SETS

(71) Applicants: Ivan Villar, Bienne (CH); Xavier Tinguely, Fontaines (CH); Florent Strahm, Sonvilier (CH)

(72) Inventors: Ivan Villar, Bienne (CH); Xavier Tinguely, Fontaines (CH); Florent Strahm, Sonvilier (CH)

(73) Assignee: ETA SA MANUFACTURE HORLOGERE SUISSE, Grenchen (CH)

(21) Appl. No.: 14/365,004

(22) PCT Filed: Nov. 27, 2012
(86) PCT No.: PCT/EP2012/073684

§ 371 Date: Jun. 12, 2014

(30) Foreign Application Priority Data
Dec. 16, 2011 (EP) 11194061.5

(51) Int. Cl. G04B 13/02; G04B 15/06

(52) U.S. Cl. CPC G04B 13/02; G04B 15/06
USPC 368/127

(57) ABSTRACT

Timepiece assembly (30) including at least two opposing wheel sets (20), coupled to each other and cooperating by contact with each other on peripheral contact surfaces (200).

Each peripheral contact surface (200) of each coupled wheel set (20) in this assembly (30) is the peripheral surface of a skin (210) of plastic material.

### FIELD OF THE INVENTION

The invention concerns a timepiece assembly including at least two opposing wheel sets, coupled to each other and cooperating by contact with each other on peripheral contact surfaces.

The invention also concerns a timepiece movement including at least one assembly of this type.

The invention also concerns a timepiece comprising at least one assembly of this type.

The invention concerns the field of horology, and more specifically the field of regulating assemblies including a balance.

### BACKGROUND OF THE INVENTION

Timepiece mechanisms, and in particular regulating assemblies, are sensitive to temperature variations.

The use of different materials, often necessary for tribological reasons, does not make the situation easier.

A timepiece balance is generally formed of a balance rim connected to a balance staff by one or more arms, a double roller which includes, on one hand a small safety-roller with a roller notch cooperating with the guard-pin of a pallet lever, and on the other hand a large roller carrying an impulse pin cooperating with a fork of the pallet lever. These various components are manufactured separately and then assembled, which is expensive.

### SUMMARY OF THE INVENTION

The invention proposes to improve timepiece mechanisms, in order to ensure their operating stability and working precision despite temperature variations, while facilitating the manufacture and assembly of components, particularly those of the regulating assemblies, such as a timepiece balance, in order to streamline production and reduce the cost thereof.

The invention therefore concerns a timepiece assembly including at least two opposing wheel sets, coupled to each other and cooperating by contact with each other on peripheral contact surfaces, characterized in that each said peripheral contact surface of each said coupled wheel set in said assembly is the peripheral surface of a skin of plastic material.

According to a feature of the invention, said skins carrying said peripheral contact surfaces of said wheel sets coupled in pairs in said assembly are made of the same plastic material.

According to a feature of the invention, said skin carrying said peripheral contact surface of at least one of two said paired opposing wheel sets in said assembly is overmoulded on a basic core.

According to a feature of the invention, said skin carrying said peripheral contact surface of each of the two said paired opposing wheel sets in said assembly is overmoulded on a basic core.

The invention also concerns a timepiece movement including at least one assembly of this type.

The invention also concerns a timepiece comprising at least one assembly of this type.

### BRIEF DESCRIPTION OF THE DRAWINGS

Other features and advantages of the invention will appear upon reading the following detailed description, with reference to the annexed Figures, in which:

FIG. 1 shows a top view of a timepiece assembly according to the invention including two opposing wheel sets cooperating with each other.

FIG. 2 shows a top view of a timepiece assembly according to the invention, including a balance and a pallet lever.

FIG. 3 shows a top view of a timepiece assembly according to the invention, including the pallet lever of FIG. 1 and an escape wheel.

FIG. 4 shows a schematic, perspective and transparent view of an application of the invention to the balance of FIG. 2.

FIG. 5 is a flow chart of a timepiece comprising a movement which includes a regulating assembly with an assembly according to the invention.

### DETAILED DESCRIPTION OF PREFERRED EMBODIMENTS

The invention concerns the field of horology, and more specifically illustrated for the field of regulating assemblies including a balance.

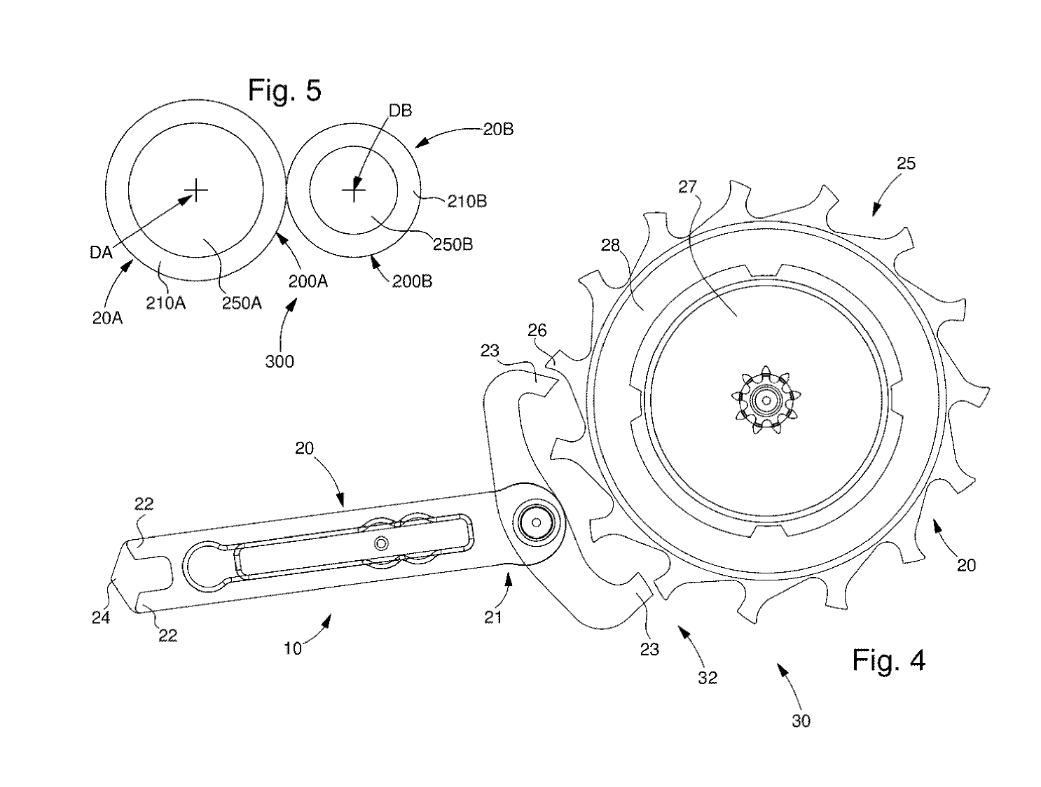

The invention concerns a timepiece assembly 30 including at least two wheel sets 20 which are opposing 20A, 20B, coupled to each other and cooperate by contact with each other on peripheral contact surfaces 200, respectively 200A, 200B, as seen in FIG. 5.

According to the invention, each peripheral contact surface 200 of each wheel set 20 coupled in this type of assembly 30 is the peripheral surface of a skin 210 of plastic material.

Preferably, the plastic material used for overmoulding skin 210 is a material having a low friction coefficient, lower than 0.15, and preferably comprised between 0.07 and 0.15, chosen to create minimum friction torque with an opposing component.

In a preferred variant, skins 210 carrying peripheral contact surfaces 200 of wheel sets 20 coupled in pairs within the same assembly 30 are made of the same plastic material.

In a preferred variant, skin 210 carrying peripheral contact surface 200 of at least one of the two paired opposing wheel sets 20 within this type of assembly 30 is overmoulded on a basic core 250.

In a particular variant, skin 210 carrying peripheral contact surface 200 of each of the two paired opposing wheel sets 20 within this type of assembly 30 is overmoulded on a basic core 250.

Advantageously, at least one skin 210 is overmoulded on a basic core 250 made of a thermally neutral material or silicon, or silicon oxide, or quartz, or similar.

Advantageously, where contact surfaces 200 develop parallel to the pivot axis of two wheel sets 20A and 20B pivoting about parallel axes DA and DB, the radial section of peripheral plastic material of skins 210 of these two wheel sets 20 is equal.

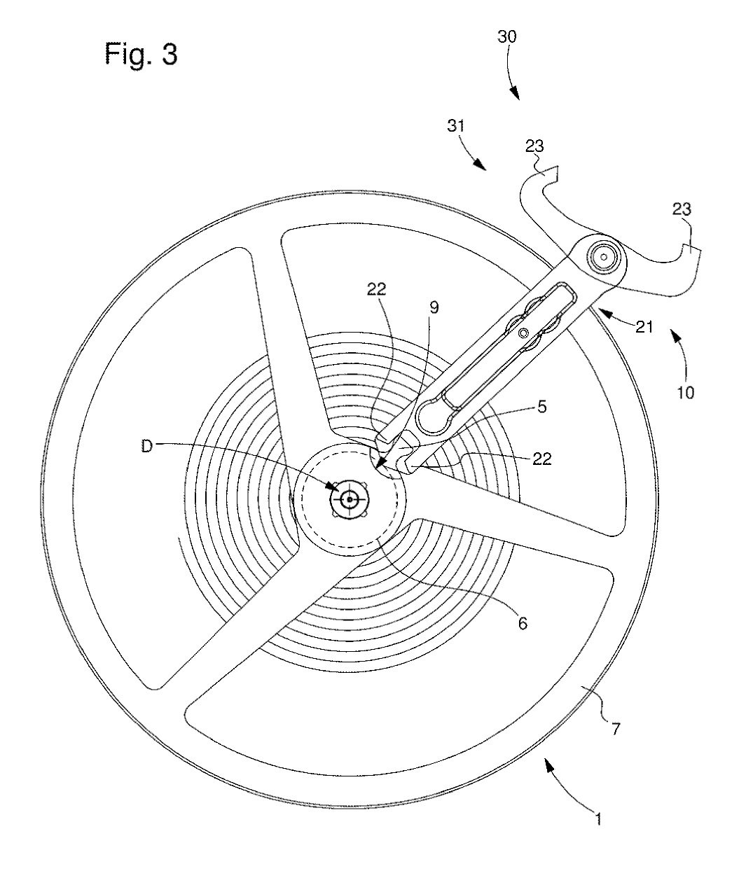

FIGS. 3 and 4 illustrate another case, where the cooperation between wheel sets 20 occurs in a perpendicular plane to the two parallel pivot axes DA, DB, of the two wheel sets 20 of the same assembly 30. In this case, it is preferable to balance the sections of peripheral plastic material, measured in a perpendicular plane to the contact point and parallel to the pivot axes of these two wheel sets 20.

The invention concerns, in particular, the wheel sets 20 of an escapement mechanism.

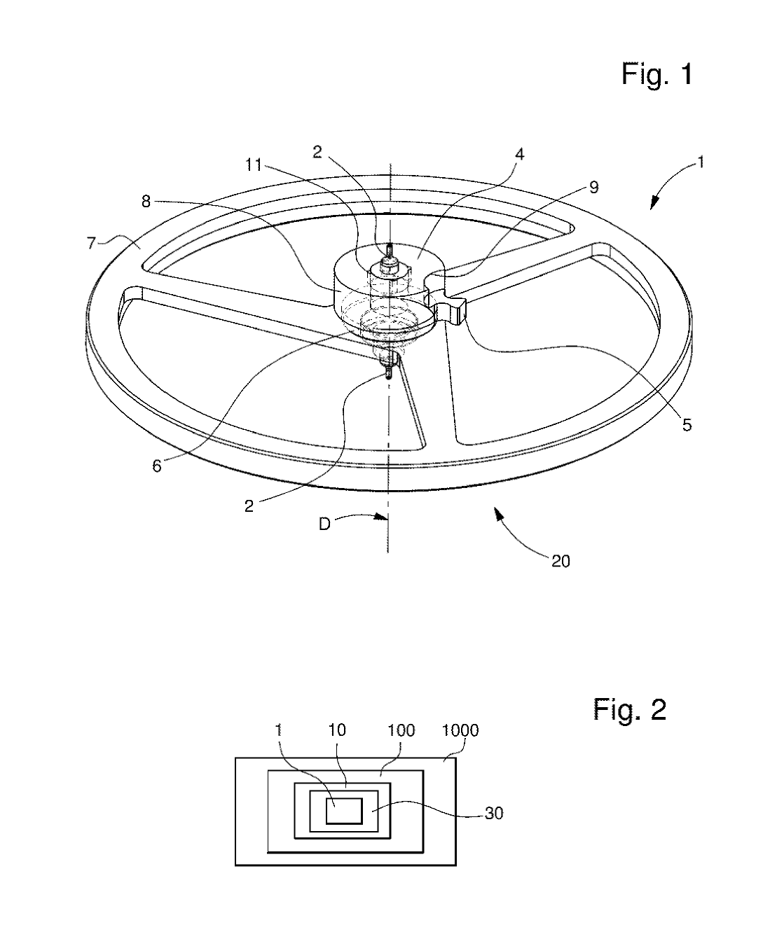

In a particular embodiment illustrated in FIGS. 1 and 2, a first wheel set 20 is a timepiece balance wheel 1 overmoulded on a balance staff 2.

According to the invention, this overmoulded balance 1 includes a small safety-roller 4 and an impulse pin 5 made of plastic material and both overmoulded on staff 2.

Advantageously, staff 2 includes a stiffening flange 6 onto which small safety-roller 4 is overmoulded. Various embodiments are possible: flange 6 is either a separate component fitted onto staff 2, and preferably locked thereon by being driven on, bonded, welded, brazed or another suitable method, or a projecting shoulder forming staff 2.

In a first embodiment, flange 6 forms a bearing surface for a rim 7 driven onto staff 2.

In a second embodiment, flange 6 forms a support frame for a rim 7 overmoulded on staff 2. In this second embodiment, balance 1 may be made according to a variant wherein it includes a rim 7 overmoulded together with small safety-roller 4 and impulse pin 5 onto staff 2 and onto flange 6. In other variants, the overmoulding may be carried out in several steps.

Advantageously, impulse pin 5 projects radially with respect to a body 8 extending small safety-roller 4 in the axial direction of balance 1.

Preferably, small safety-roller 4 is cylindrical and includes a peripheral roller notch 9. Advantageously, body 8 is also cylindrical, of the same diameter as small safety-roller 4, and impulse pin 5 is carried by a radial arm in relation to body 8 and aligned on roller notch 9.

In this preferred version where small safety-roller 4 includes a peripheral roller notch 9 radially aligned on impulse pin 5, small safety-roller 4 and impulse pin 5 are sized so that the main axis of inertia of the assembly that they form with each other is identical to axis D of balance 1.

Advantageously, balance staff 2 includes substantially radial wings for anchoring the plastic overmoulding material, and wings 11 are balanced relative to axis D of balance 1.

Preferably, the plastic material used for overmoulding small safety-roller 4 and impulse pin 5 is a material having a low friction coefficient, lower than 0.15, and preferably comprised between 0.07 and 0.15, chosen to create minimum friction torque with a pallet lever with which the balance cooperates, depending on the material of the pallet lever.

FIG. 3 illustrates an assembly 31 including a balance 31 and a pallet lever 21.

As seen in FIGS. 3 and 4, another wheel set 20 is thus a pallet lever 21, which includes horns 22 cooperating with impulse pin 5, a guard-pin 24 cooperating with roller notch 9 and pallet stones 23 arranged to cooperate with an escape wheel 25. This pallet lever 21 is at least partially made of plastic material;
or it is entirely made of plastic material;
or preferably, as will be seen below, at least on the areas of cooperation thereof with balance 1 (horns 22) and the escape wheel 25 (pallet stones 23), it includes a plastic skin 210, overmoulded on a core 250 made of another material, for example stamped, foundry based, silicon, silicon oxide, or quartz or similar.

FIG. 4 illustrates another assembly 32 including a pallet lever 21 of this type and another wheel set 20 which is an escape wheel 25, including teeth 26 cooperating with pallet stones 23 of pallet lever 21.

This escape wheel 25 is at least partially made of plastic material:
or it is entirely made of plastic material;
or, preferably, as will be seen below, at least on one of the areas of cooperation thereof with pallet lever 21 formed by teeth 26, it includes a plastic skin 210, overmoulded 28 on a core 27 made of another material, for example stamped, foundry based, silicon, silicon oxide or quartz or similar.

In both cases, assembly 30, 31 or 32 is arranged so that the mechanism is thermocompensated, i.e. the thermal expansions are such that, at the contact interface point between the opposing peripheral contact surfaces 200 (horn 22—impulse pin 5 for assembly 31, tooth 26—pallet stone 23 for assembly 32), the relative expansions of the two opposing wheel sets do not cause any differential displacement of this interface point. Thus, surface bulging or shrinkage do not cause any unwanted play during operation.

The composite overmoulded fabrication of at least one of the two wheel sets 20 of each assembly 30 makes it possible to limit the peripheral quantity of plastic overmoulding material, to provide an equivalent plastic expansion or contraction to that of the opposing part. Naturally, in an optimum manner, in a pair of opposing wheel sets 20 of the same assembly 30, the basic core or body 250 onto which skin 210 of each wheel set 20 is overmoulded is devised to have a radial expansion, in relation to its pivot axis, equivalent to that of the basic core or body 250 onto which skin 210 of the opposing wheel set 20 is overmoulded. It is advantageous in this regard to make these basic cores or bodies 250 in relatively thermally inert materials, particularly materials from micro-technologies, silicon or suchlike. The peripheral overmoulding makes it possible to give the contact areas 200 of wheel sets 20 different tribological properties from those of the basic cores or bodies 250.

Thus, as regards balance 1, small safety-roller 4 is preferably overmoulded only at the radial periphery of stiffening flange 6.

In the case of escape wheel 25, core 27, made for example in the form of an intermediate washer or star wheel, makes it possible to limit the quantity of overmoulded plastic material on the periphery 28 of escape wheel 25, to obtain an equivalent expansion of plastic material to that of pallet lever 21 on its pallet stones 23. A thermocompensated system is thus obtained between teeth 26 and pallet stones 23 of pallet lever 21.

In the case of overmoulded balance 1, the same property can be obtained, to achieve a thermocompensated system between impulse pin 5 and horns 22 of pallet lever 21.

It is understood that, for these two assemblies 31, 32, overmoulding pallet lever 21 onto a core makes it possible to affect the quantity of material subject to expansion/contraction on the pallet lever, which allows specific dimensions to be given to small safety-roller 4 and/or flange 6 thereof on the one hand, and peripheral area 28 and its core 27 on the other hand.

Preferably, the same material is used for overmoulding (or completely making) each wheel set 20 of an assembly 30 in order to ensure thermocompensation without using any other device.

An assembly 30 with more than two wheel sets 20 is formed, in the present example, by combining assemblies 31, 32 around the same pallet lever 21 on either side of which the balance 1 and escape wheel 25 interact, each made in accordance with the features set out above.

The invention also concerns a timepiece regulating assembly 10 including at least one such assembly 30 and in particular including an overmoulded balance 1 of this type.

The invention also concerns a timepiece movement 100 including at least one timepiece regulating assembly 10 or at least one assembly 30 of this type.

The invention also concerns a timepiece 1000 including at least such a timepiece movement 100 or at least one timepiece regulating assembly 10 or at least one assembly 30 of this type.

Although the invention is described in a particularly advantageous application which is that of an escapement mechanism, those skilled in the art will understand that it is applicable to other configurations inside a timepiece, especially where an expansion differential between opposing wheel sets is likely to disrupt operation, adversely affect efficiency or even lock a mechanism. Thus, this description is not limited to the particular mechanisms described.

1.-14. (canceled)

15. A timepiece assembly including at least two opposing wheel sets, coupled to each other and cooperating by contact with each other on peripheral contact surfaces, wherein each said peripheral contact surface of each said coupled wheel set in said assembly is the peripheral surface of a skin of plastic material, wherein said skin carrying said peripheral contact surface of each of the two said opposing wheel sets paired within said assembly is overmoulded onto a basic core, in that the cooperation between said wheel sets pivoting about parallel pivot axes occurs in a perpendicular plane to said pivot axes, and in that the sections of peripheral plastic material, measured in a plane perpendicular to the point of contact and parallel to said pivot axes of said two wheel sets are equal.

16. The timepiece assembly according to claim 15, wherein said skins carrying said peripheral contact surfaces of said wheel sets coupled in pairs within said assembly are made of the same plastic material.

17. The timepiece assembly according to claim 15, wherein said contact surfaces develop parallel to the pivot axis of two said wheel sets pivoting about parallel axes, and in that the radial section of peripheral plastic material of said skins of said two wheel sets is equal.

18. The timepiece assembly according to claim 15, wherein the assembly is thermocompensated, and in that, at the contact interface point between said opposing peripheral contact surfaces, the relative expansions of said two opposing wheel sets does not cause any differential displacement of said interface point.

19. The timepiece assembly according to claim 15, wherein the assembly is an assembly including, as said wheel sets cooperating with each other, on the one hand a balance wheel including a small safety-roller including a roller notch and an impulse pin made of plastic material overmoulded on a stiffening flange, and on the other hand a pallet lever including horns cooperating with said impulse pin and a guard-pin cooperating with said roller notch and pallet stones arranged to cooperate with an escape wheel, said pallet lever being at least partially made of plastic material.

20. The timepiece assembly according to claim 19, wherein said pallet lever includes, at least on said horns thereof appertaining to the peripheral contact surfaces with said balance, a said skin overmoulded onto a basic core.

21. The timepiece assembly according to claim 19, wherein said pallet lever comprises at least on said pallet stones thereof, a said skin overmoulded onto a basic core.

22. The timepiece assembly according to claim 15, wherein the assembly is an assembly including, as said wheel sets cooperating with each other, on the one hand a pallet lever including horns and a guard-pin arranged to cooperate with a balance and pallet stones arranged to cooperate with an escape wheel, said pallet lever being at least partially made of plastic material, and on the other hand, an escape wheel including teeth cooperating with said pallet stones, and in that said escape wheel is at least partially made of plastic material, and includes, at least on said peripheral surfaces in contact with said pallet lever formed by said teeth, a said skin of plastic material overmoulded onto a basic core.

23. The timepiece assembly according to claim 22, wherein the assembly is an assembly including, as said wheel sets cooperating with each other, on the one hand a balance wheel including a small safety-roller including a roller notch and an impulse pin made of plastic material overmoulded on a stiffening flange, and on the other hand a pallet lever including horns cooperating with said impulse pin and a guard-pin cooperating with said roller notch and pallet stones arranged to cooperate with an escape wheel, said pallet lever being at least partially made of plastic material and wherein the assembly is made by combining said assemblies around the same said pallet lever on either side of which said balance and said escape wheel interact.

24. The timepiece assembly according to claim 15, wherein at least one said skin is overmoulded onto a basic core made in a thermally neutral material or silicon, or silicon oxide or quartz.

25. The timepiece assembly according to claim 15, wherein the assembly includes a timepiece balance overmoulded onto a balance staff, which includes a small safety-roller and an impulse pin made of plastic material, together overmoulded onto said staff, said staff including a stiffening flange onto which said small safety-roller is overmoulded, and in that said impulse pin projects radially in relation to a body extending said small safety-roller in the axial direction of said balance.

26. The timepiece assembly according to claim 25, wherein said balance includes a rim overmoulded, together with said small safety-roller and with said impulse pin, onto said staff and onto said flange.

27. The timepiece movement including at least one timepiece assembly according to claim 15.

28. The timepiece including at least one timepiece assembly according to claim 15.
